(19) United States
(12) Patent Application Publication
(10) Pub. No.: US 2017/0306927 A1
(43) Pub. Date: Oct. 26, 2017

(54) CABLE TO TEMPORARILY STORE & TRANSPORT KINETIC-ENERGY FROM COLLECTOR TO GENERATOR

(71) Applicant: Roberto Vallejo, Los Angeles, CA (US)

(72) Inventor: Roberto Vallejo, Los Angeles, CA (US)

(21) Appl. No.: 15/478,178

(22) Filed: Apr. 3, 2017

Related U.S. Application Data
(60) Provisional application No. 62/324,994, filed on Apr. 20, 2016.

(51) Int. Cl. F03D 9/25; F03D 80/80; F03D 13/20; F03D 15/00; F03D 3/00; F03D 1/00

(52) U.S. Cl. CPC F03D 9/25; F03D 3/005; F03D 1/00; F03D 13/20; F03D 15/00; F03D 80/88

(57) ABSTRACT

A temporary kinetic energy storage-holder and energy transfer devise, comprising of a rotating cable preferably of steel, between two fixed rotating points each a thrust bearings and a one direction rotation hub at the kinetic energy source, coupled to at one end to a kinetic energy capturing devise such as wind turbine, water wheel, animal human or any other kinetic energy generating or collector devise, and at the other end, coupled to an electricity generating devise, a generator, directly or via a geared speed modifier to control generator impute. And all this attached to a supporting structure, tower, pole, pipe column or the ground, to transform kinetic energy into electricity.

### CROSS REFERENCE TO RELATED APPLICATION

This application claims benefit of filling of U.S. Provisional Application No. 62/324,994, filed on Apr. 20, 2016; by Roberto Vallejo, Applicant/Inventor, titled “Cable to Store Transfer Kinetic Energy from Collector to Generator”.

### FIELD OF INVENTION

The present invention relates to power developing fluid turbines, air or water, collecting, temporarily storing and transferring torque via a cable, torsion spring, in wind turbines or water wheel, relocating most heavy equipment from up high in the air to ground level in air turbines and on water wheel locating electric and electronic sensitive equipment away from water's edge.

### BACKGROUND OF THE INVENTION

Kinetic energy, collection, storage, increase of power and then transfer it to be used right after or at a later time or to a different place, has been part of humans since time immemorial, such as the use of water in small and later larger and larger water ponds, to use the stored water, on water wheels, agriculture, hydroelectricity, or the like. Originally used to store water and food resources such as fish or others foods in or around small water ponds, then latter to move water from a lower level to a higher level for fields irrigation or consumption, later on to use the force of the stored water on wheels, then wheels with axels in shops thru shafts with pulleys and belts to operate machinery, then more recently to extract hydroelectricity. Wind has also been used as a resource to extract kinetic energy in the form of windmills that until recently were used as the raw power energy of industry, mining, lumber, foods, to mill minerals, wood, grains, extract liquids from different product, also to remove water to augment land for humans use. The storage of energy in all forms whether for short or long time, has been vital to humanity.

Today's wind turbines varied greatly in size shape design, and are mainly use for producing electricity to be used in every facet of modern life, from residential to commercial to industrial uses; the present invention advances some of this concepts that will become clear in the following explanations.

### SUMMARY OF THE INVENTION

This devise consists of:
1) A tall tower or long structure, anchored to a foundation.
2) A kinetic energy collector at power source a wind turbine or water wheel.
3) An electric generator at opposite end, an optional speed modifier may be added.
4) A long rotating twisted cable, loose or taut, or torsion-spring; preferably steel, but equally capable, metallic, organic, high tech material may be used, coupled from collector to generator.
5) A one way-hub/unidirectional-ratchet positively coupled to tower, collector and rotating cable.
6) Thrust bearings, about top and bottom of rotating cable.

How Parts are Put Together:

On a tall tower structure a long rotating twisted steel cable/torsion-spring stretches connected from an energy collector a turbine at power source end tower top to a generator at opposite end at tower base foundation, a speed modifier may be added to control impute to generator; thrust bearings about cable ends positively anchored from rotating cable to tower, a unidirectional-ratchet/one-way-hub at power source end positively anchored to the energy collector the tower and rotating cable via collector extended axel at top; this two thrust bearings and unidirectional-ratchet/one-way-hub prevent reverse unwinding and pulling of the cable when under twisted stored torque that is held by the generator/speed-modifier friction at bottom end in lower wind conditions, but under mid to higher winds the torque is transferred to speed-modifier/generator to create work i.e. electricity; universal joint may be added to cable ends to control rotating misalignments of twisting components; the cable/torsion-spring must be twisted in the same direction of rotation; all rotating connections to be concentric with the axels of rotation; the energy collector be a VAWT, HAWT, or Water Wheel may be axially supported via extended axel for robust anchoring.

How the Device Works:

Atop a tall strong tower securely anchored to a ground base foundation, a securely anchored VAWT via its extended axis rotates under wind forces; this VAWT coupled to a generator, securely anchored at base, via a rotating twisted cable/torsion spring, twisted in the same direction the VAWT rotates; at tower top a unidirectional ratchet positively coupled to the VAWT extended axel and the tower, allows the cable coupled to this VAWT extended axel to rotate in one direction only, preventing its' unwinding; thrust bearings positively coupled at top and bottom, from cable to tower via trusses plates or the like, allowing for cable rotation in twisted tight tension to maintain distance and fixed location of thrust bearings, thrust bearing may be coupled indirectly to cable via extended axel at top and universal joint at bottom. As the VAWT rotates under wind forces atop the VAWT rotation torque is pushed down the axel to the cable to the generator at tower base directly or via a speed modifier, that at lower wind forces the VAWT torque rotations may not be sufficient to overcome the speed-modifier/generator friction so the cable twists and tightens increasing stored energy and does not reverses or unwinds prevented by the unidirectional ratchet at top and the speed-modifier/generator friction at bottom, as the wind adds twists, the cable tightens and wants to shrink and pull but it is prevented by the positively fixed anchored thrust bearings that hold firm in place allowing for increased stored torque in the cable between the thrust bearings to be added under lower winds, relative to apparatus size, but an increase torque force via the wind turbine rotation of forces strong enough to overcome that friction, the speed-modifier/generator and all components coupled to the cable starts to rotate, for a time at least, with the stored and increased energy in the cable, even under no added forces, (as it takes less force to rotate a moving object than a static one), but when wind forces are above the minimum required to rotate the apparatus then the speed-modifier/generator will continue to rotate pushed by the rotating cable generating electricity for as long as the wind forces are just above this minimum threshold required to rotate the moving apparatus, and the stronger the forces the faster the rotation the more kinetic energy is transformed into more electricity via the generator which is the whole idea.

Someone versed in the art would understand that some functions of the device may be performed by similarly interchangeable components that perform equally without affecting functionality or effectiveness of the device function, i.e., cable or torsion spring; one-way-hub or unidirectional ratchet, materials or others.

This device also functions transferring kinetic energy from a horizontal axes wind turbine (HAWT) from high up a tower to a generator below via this twisted steel cable, where the horizontal rotating axel of the HAWT is anchored to the nacelle via front and back ball bearings, the nacelle positively anchored to the tower top via a ball bearing about its balance base, and concentric with an angled geared differential that redirects horizontal torque forces to a vertical direction, this nacelle base ball bearing allows the rotation of the nacelle via a fin or yaw mechanism to face the wind totally independent from the horizontal and vertical axel rotation; this gear angle vertical axel that acts in similar manner as the VAWT extended axel is positively coupled to rotating cable, that extends down to the generator at the tower base, and transfers torque to the generator in same manner with similar components as in the VAWT device.

Advantages of this Device:

This device allows the placement of some of the heavy equipment, generator transmission electronics and other heavy components at floor level in the air power producing turbine allowing for a more efficient: design and construction of equipment maintenance, lower labor and materials costs, and equipment life time along many more benefits. And like wise in the water wheel version, with the electric, electronic, and other components away from waters' edge, many benefits are obvious to one versed in the art in all versions.

### DESCRIPTION OF DRAWINGS

FIG. 1, Turbine 100, shows the devise in a preferred embodiment, the cable in a (VAWT) wind turbine.

FIG. 2, turbine 200 shows the transfer of a HAWT torque forces from horizontal direction to vertical direction, a variation of the preferred embodiment.

### DESCRIPTION OF PREFERRED EMBODIMENTS

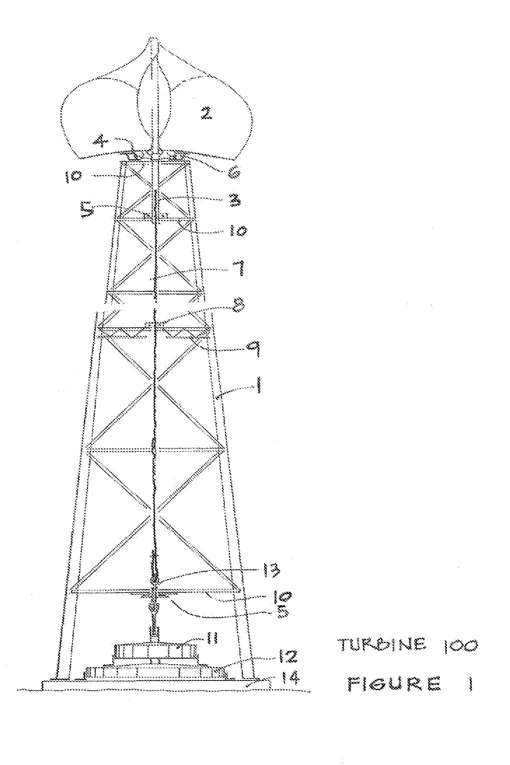

FIG. 1 Turbine 100 along with corresponding reference numbers of parts shows a prefer embodiment of the devise, an apparatus that collects wind kinetic energy, atop a robustly ground secured tall tower 1 structure, via a (vertical axis wind turbine) VAWT 2 positively anchored at tower 1 top via its' extended axel 3 for robust support and transmits this kinetic energy via a rotating twisted cable/torsion-spring 7 positively couple at top to extended axel 3, down to an electric generator 12 that is securely anchored at tower base foundations 14, directly or thru a geared speed modifier 11; this long, twisted in the rotating direction, cable/torsion-spring 7 securely anchored via thrust bearings 5 with plates 10 trusses 9 or the like, directly to tower 1, or indirectly, at top thru the VAWT extended axel 3 and at bottom thru a universal joint 13, to maintain in a fix position and constant cable 7 length between these top and bottom thrust bearings 5, and to prevent cable 7 puling tension forces to pass above to collector 2 and gearing 11 bellow; a unidirectional-ratchet/one-way-hub 4 at tower top positively coupled to tower 1 VAWT 2 and twisted cable/torsion spring 7 directly or thru extended axel 3, controls the reverse rotation and unwinding of the cable 7 at top; additional support bearings 8 may be added to cable 7 coupled to tower via plates 10 or trusses 9 when long and heavy as needed along its length; universal joints 13 may couple cable 7 ends to rotating components to accommodate misalignments of rotation; as the wind pushes the rotation of the VAWT 2 thru extended axel 3 down cable 7 that rotates along the axes of rotation down to the generator 12 thru speed modifier 11 producing electricity in stronger winds, but in lower winds as the VAWT 2 rotates along with the cable 7, the speed modifier 11 electric generator 12 friction stops the rotation at the bottom that continues to accumulate on a twisted tense cable 7 that wants to unwind and decompress but the unidirectional-ratchet/one-way-hub 4 prevents the reverse unwinding, while top and bottom thrust bearings 5 prevent the decompression of the cable 7 while holding this stored kinetic energy that augments and increases with added turns of the VAWT 2, till wind forces are strong enough to overcome this friction at the speed increaser 11 generator 12 at which time all rotating parts start moving producing electricity thru the generator 12, at least for a time with the stored and increased energy in the cable 7, even under no added forces (as it takes less force to rotate a moving object than a static one) but when forces are added above the minimum required to rotate the apparatus then the speed-modifier 11/generator 12 will continue to rotate pushed by the VAWT 2 its extended axis 3 down the rotating cable 7 to the generator 12, generating electricity, for as long as the wind forces are just above this minimum threshold required to rotate the moving apparatus, and the stronger the forces the faster the rotation the more kinetic energy is transformed into electricity via the generator 12 which is the whole point.

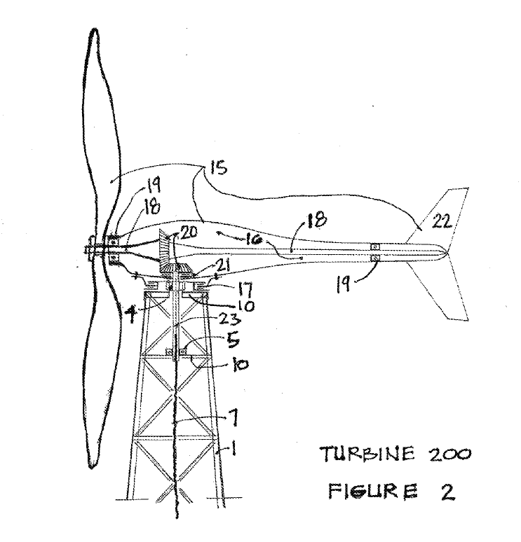

In another embodiment FIG. 2 Turbine 200 depicts another kinetic energy collector, a horizontal axis wind turbine (HAWT) 15, its horizontal rotating axes 18 coupled to ball bearings 19 anchored at front and back of the nacelle 16. At a point somewhere about the center of gravity balance point of the HAWT 15, an angled geared differential 20 that transfers horizontal torque forces down to vertical direction via a vertical axel 23 that, may also combine thrust bearing 21 and a unidirectional ratchet 4, transfers the rotation forces of the HAWT 15 in one direction only, from the horizontal axis 18 to a vertical axis 23, this short vertical axel 23 acts in the same manner as the VAWT 2 extended axel 3 of FIG. 1 Turbine 100, where the twisted steel cable torsion spring 7 is positively coupled to angled geared 20 via vertical axel 23, this cable 7 extends to the generator 12 in the same manner as in FIG. 1 Turbine 100; concentric with this angled geared 20 vertical axel 23 a ball bearing 17 positively anchored to the tower 1 top and HAWT nacelle 16 are concentric along vertical axis rotation, allows the nacelle 16 to rotate freely, via a yaw or horizontal directional fin 22, 360 degrees to face the wind; this nacelle rotation is totally independent of angled geared vertical or horizontal rotation.

In another embodiment, not shown, the kinetic energy collector maybe a water wheel, in this case the supporting structure may be lay down on its side not vertical, and all the components which are virtually the same as in FIG. 1 turbine 100 except the collector is a water wheel, all this which can easily be assembled by someone versed in the art, in the same manner and sequence and functionality, but lay down on its side and the wind turbine 2 be replaced by a water wheel and the electricity generating components located far away from the damaging water.

It should be appreciated that size scale and dimensions of the apparatus are exemplary only and all dimensions scale and size of the parts can vary independent of or in conjunction with one or multiple or all parts of the devise in such a way apparent to one versed in the art.

The invention has been described herein using specific embodiments for the purpose of illustration only. It will be readily apparent to one of ordinary skill in the art, however, that the principals of the invention can be embodied in other ways. Therefore the invention should not be regarded as being limited in scope to the specific embodiments disclosed herein, but instead fully commensurate in scope with the following claims.

I claim:

1. A power producing fluid turbine consisting of: a tall tower, an energy collector at tower top, an electricity generator at tower base; a twisted rotating cable connected from collector to generator; two thrust bearings on cable one at top the other at bottom; a unidirectional ratchet at tower top.

2. The power producing turbine of claim 1 where the energy collector is a vertical axis wind turbine (VAWT) with an extended axle into tower top for robust anchoring.

3. The power producing turbine of claim 2 where the cable is twisted in rotation direction, may be loose or taut, of any material capable of performing task preferably high torsion steel.

4. The power producing turbine of claim 2 where the unidirectional ratchet controls the reverse unwinding of the cable.

5. The power producing turbine of claim 2 where the thrust bearings are positively coupled to rotating cable directly or indirectly via VAWT extended axel at top and universal joint at bottom and directly to tower via plates or trusses and maintain a constant distance to each other.

6. The power producing turbine of claim 5 where the top and bottom thrust bearings in conjunction with unidirectional ratchet temporarily stores torque energy in the cable, prevent tension passing to gearing below, and prevent reverse rotation to collector at top.

7. The power producing turbine of claim 2 where the generator may have a geared speed modifier.

8. The power producing turbine of claim 2 where the cable may have additional supports along its length.

9. The power producing turbine of claim 2 where the cable be a torsion spring or a loose set of wires.

10. The power producing turbine of claim 2 where the cable may be couple at ends to rotating elements via universal joints to control rotation misalignments.

11. The power producing turbine of claim 1 where the energy collector be a HAWT with an angled gear to redirect rotational horizontal forces to a downward vertical direction, and concentric with a rotating ball bearing seat at nacelle balance point allows the nacelle free 360 degrees rotation to face the wind via fins or yaw mechanism.

12. The power producing turbine of claim 11 where the cable is twisted in rotation direction and may be loose taut or of any material capable of performing task preferably high torsion steel.

13. The power producing turbine of claim 11 where the unidirectional ratchet controls the reverse unwinding of the cable.

14. The power producing turbine of claim 11 where the thrust bearings are positively coupled to rotating cable directly or indirectly via gear angled vertical extended axel at top and universal joint at bottom and directly to tower via plates or trusses and maintain a constant distance.

15. The power producing turbine of claim 11 where the top and bottom thrust bearings in conjunction with unidirectional ratchet temporarily stores torque energy in the cable, prevent tension passing to gearing below or reverse rotation to collector at top.

16. The power producing turbine of claim 11 where the generator may have geared speed modifier

17. The power producing turbine of claim 11 where the cable may have additional supports along its length.

18. The power producing turbine of claim 11 where the cable be a torsion spring or a loose set of wires.

19. The power producing turbine of claim 11 where the cable is couple at ends to rotating elements via universal joints to control rotation misalignments.

20. The power producing turbine of claim 1 where the tall tower is laid on its side, the energy collector is a water wheel at waters' edge and the generator with optional speed modifier be located away from waters' edge.
